(19) United States
(12) Patent Application Publication
(10) Pub. No.: US 2022/0414963 A1
(43) Pub. Date: Dec. 29, 2022

(54) HAIR RENDERING METHOD AND APPARATUS, ELECTRONIC DEVICE AND STORAGE MEDIUM

(71) Applicant: BEIJING DAJIA INTERNET INFORMATION TECHNOLOPGY CO., LTD., Beijing (CN)

(72) Inventors: Peihong HOU, Beijing (CN); Chongyang MA, Beijing (CN)

(21) Appl. No.: 17/897,309

(22) Filed: Aug. 29, 2022

Related U.S. Application Data
(63) Continuation of application No. PCT/CN2020/129859, filed on Nov. 18, 2020.

(30) Foreign Application Priority Data
Mar. 27, 2020 (CN) 202010230272.6

(51) Int. Cl. G06T 13/40; G06T 11/00; G06T 15/04

(52) U.S. Cl. CPC G06T 13/40; G06T 11/001; G06T 15/04

(57) ABSTRACT

A hair rendering method includes acquiring a target video containing hair information, and selecting a target image frame from image frames of the target video, acquiring a texture image of the target image frame, wherein the texture image is an image in a texture format which records motion states and state change information of one or more pixel points in the target image frame.

The method further includes acquiring a first target motion state and target state change information of a first target particle region from the texture image; determining a second target motion state of the first target particle region in a next image frame according to the first target motion state and the target state change information, and rendering the hair region by updating a motion state in the texture image according to the second target motion state.

### CROSS-REFERENCE TO RELATED APPLICATION

This application is a continuation application of International Application No. PCT/CN2020/129859, filed Nov. 18, 2020, which claims priority to and benefits of Chinese Patent Application No. 202010230272.6, filed on Mar. 27, 2020, the entire content of which is incorporated herein by reference.

### FIELD

The present disclosure relates to the field of image processing technology, and more particularly to a hair rendering method and apparatus, an electronic device and a storage medium.

### BACKGROUND

With the development of live streaming and other technologies, real-time rendering technology is more and more widely used in mobile terminals, for example, to dye or soften the user's hair in images and videos during a live streaming process.

### SUMMARY

According to one aspect of embodiments of the present disclosure, a hair rendering method is provided, which includes acquiring a target video containing hair information, and selecting a target image frame from image frames of the target video, and acquiring a texture image of the target image frame, wherein the texture image is an image in a texture format which records motion states and state change information of one or more pixel points in the target image frame, and a hair region in the texture image is divided into at least one particle region by a grid line.

The method further includes acquiring a first target motion state and target state change information of a first target particle region from the texture image, wherein the first target particle region is any region of the at least one particle region, determining a second target motion state of the first target particle region in a next image frame according to the first target motion state and the target state change information, wherein the next image frame is an image frame in the target video next to the target image frame, and rendering the hair region by updating a motion state in the texture image according to the second target motion state.

According to another aspect of embodiments of the present disclosure, an electronic device is provided, which includes: a processor; and a memory, configured to store an instruction executable by the processor, wherein the processor is configured to acquire a target video containing hair information, and select a target image frame from image frames of the target video, and acquire a texture image of the target image frame, wherein the texture image is an image in a texture format which records motion states and state change information of one or more pixel points in the target image frame, and a hair region in the texture image is divided into at least one particle region by a grid line. The processor is further configured to acquire a first target motion state and target state change information of a first target particle region from the texture image, wherein the first target particle region is any region of the at least one particle region, determine a second target motion state of the first target particle region in a next image frame according to the first target motion state and the target state change information, wherein the next image frame is an image frame in the target video next to the target image frame, and render the hair region by updating a motion state in the texture image according to the second target motion state.

According to another aspect of embodiments of the present disclosure, a storage medium is provided, which has stored therein instructions that, when executed by a processor of an electronic device, cause the electronic device to acquire a target video containing hair information, and select a target image frame from image frames of the target video, and acquire a texture image of the target image frame, wherein the texture image is an image in a texture format which records motion states and state change information of one or more pixel points in the target image frame, and a hair region in the texture image is divided into at least one particle region by a grid line. The electronic device is further configured to acquire a first target motion state and target state change information of a first target particle region from the texture image, wherein the first target particle region is any region of the at least one particle region, determine a second target motion state of the first target particle region in a next image frame according to the first target motion state and the target state change information, wherein the next image frame is an image frame in the target video next to the target image frame, and render the hair region by updating a motion state in the texture image according to the second target motion state. According to another aspect of the present disclosure, a computer program product is provided. The program product includes a computer program, and the computer program is stored in a readable storage medium. The computer program, when read from the readable storage medium and executed by at least one processor of a device, causes the device to acquire a target video containing hair information, and select a target image frame from image frames of the target video, and acquire a texture image of the target image frame, wherein the texture image is an image in a texture format which records motion states and state change information of one or more pixel points in the target image frame, and a hair region in the texture image is divided into at least one particle region by a grid line. The at least one processor of the device further causes the device to acquire a first target motion state and target state change information of a first target particle region from the texture image, wherein the first target particle region is any region of the at least one particle region, determine a second target motion state of the first target particle region in a next image frame according to the first target motion state and the target state change information, wherein the next image frame is an image frame in the target video next to the target image frame, and render the hair region by updating a motion state in the texture image according to the second target motion state. It should be appreciated that, the general description hereinbefore and the detail description hereinafter are explanatory and illustrative, and shall not be construed to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure, and shall not be construed to improperly limit the present disclosure.

FIG. 1 is a diagram showing an application environment of a hair rendering method according to an exemplary embodiment.

FIG. 2 is a flow chart showing a hair rendering method according to an exemplary embodiment.

FIG. 3 is a schematic diagram showing particle bunches according to an exemplary embodiment.

FIG. 4 is a schematic diagram showing a displaying effect of hair rendering according to an exemplary embodiment.

FIG. 5 is a flow chart showing a hair rendering method according to another exemplary embodiment.

FIG. 6 is a block diagram showing a hair rendering apparatus according to an exemplary embodiment.

### DETAILED DESCRIPTION

In order to make those ordinarily skilled in the art better understand the technical solutions of the present disclosure, the technical solutions in embodiments of the present disclosure will be described clearly and completely below with reference to the accompanying drawings.

It should be noted that the terms “first”, “second” and the like in the specification, claims and the accompanying drawings of the present disclosure are used to distinguish similar objects, and not necessarily used to describe a specific order or sequence. It should be understood that the terms so used may be interchangeable where appropriate, such that embodiments of the present disclosure described herein may be implemented in a sequence other than those illustrated or described herein. The embodiments described in the following illustrative examples are not intended to represent all embodiments consistent with the present disclosure. On the contrary, they are merely examples of devices and methods consistent with some aspects of the present disclosure as recited in the appended claims.

At present, pixels in a hair region are rendered by such as color replacement or a blurring treatment through a CPU (central processing unit) on a PC (personal computer) terminal or a server terminal.

However, the current rendering methods have a large computation burden, and the processing of the CPU on hair particle information is often complicated, it is impossible to achieve real-time rendering on the mobile terminal. At present, the demand for live broadcast through mobile terminals is increasing, so it is necessary to provide a method that can render hair in real time on mobile terminals.

The preset disclosure provides a hair rendering method and apparatus, an electronic device and a storage medium, to solve at least the problem existing in the related art that the hair cannot be rendered in real time on the mobile terminal. The technical solutions of the present disclosure are as follows.

According to embodiments of the present disclosure, a hair rendering method is provided, which includes: acquiring a target video containing hair information, and selecting a target image frame from image frames of the target video; acquiring a texture image of the target image frame, wherein the texture image is an image in a texture format which records motion states and state change information of one or more pixel points in the target image frame, and a hair region in the texture image is divided into at least one particle region by a grid line; acquiring a first target motion state and target state change information of a first target particle region from the texture image, wherein the first target particle region is any region of the at least one particle region; determining a second target motion state of the first target particle region in a next image frame according to the first target motion state and the target state change information, wherein the next image frame is an image frame in the target video next to the target image frame; and rendering the hair region by updating a motion state in the texture image according to the second target motion state.

In some embodiments, the updating the motion state in the texture image according to the second target motion state includes: updating a motion state of the first target particle region according to the second target motion state, and retaining a motion state of a remaining particle region. The remaining particle region is a particle region of the at least one particle region other than the first target particle region.

In some embodiments, the first target motion state includes a first screen coordinate, and the target state change information includes a first speed. The determining the second target motion state of the first target particle region in the next image frame according to the first target motion state and the target state change information includes: determining a time difference between the target image frame and the next image frame; determining a second screen coordinate of the first target particle region in the next image frame according to the first screen coordinate, the first speed and the time difference; and determining the second target motion state based on the second screen coordinate.

In some embodiments, the updating the motion state in the texture image according to the second target motion state includes: in response to the second screen coordinate being outside the hair region, redetermining the hair region of the texture image and determining a second target particle region from particle regions corresponding to the redetermined hair region; acquiring a reference target motion state and a reference target state change information of the second target particle region from the texture image; obtaining a third target motion state by determining a motion state of the second target particle region in the next image frame according to the reference target motion state and the reference target state change information; and updating the motion state in the texture image according to the third target motion state.

In some embodiments, the first target motion state includes a second speed, and the target state change information includes a hair directional angle. The determining the second target motion state of the first target particle region in the next image frame according to the first target motion state and the target state change information includes: acquiring a preset rate; and obtaining the second target motion state by determining a third speed of the first target particle region in the next image according to the second speed, the hair directional angle and the preset rate.

In some embodiments, before the acquiring the texture image of the target image frame, the hair rendering method further includes: determining candidate state change information of each pixel point in the target image frame according to pixel state information in the target video which varies over time; acquiring a hair directional map and a hair region mask map corresponding to the target image frame, wherein the hair directional map includes a hair directional angle of the pixel point, and the hair region mask map includes mask information of the hair region in the target image frame; determining a candidate motion state of the pixel point according to the hair directional angle in the hair directional map and the mask information in the hair region mask map; and storing the candidate state change information and the candidate motion state to a vertex position of the at least one particle region, wherein the vertex position of the at least one particle region corresponds to the pixel point.

In some embodiments, after storing the candidate state change information and the candidate motion state to the vertex position of the at least one particle region, the hair rendering method further includes: storing the texture image to a first frame buffer; and after updating the motion state in the texture image according to the second target motion state, the hair rendering method further includes: storing the texture image in the first frame buffer to a second frame buffer; and storing an updated texture image to the first frame buffer.

In some embodiments, after acquiring the texture image of the target image frame, the hair rendering method further includes: determining the hair region in the texture image; meshing the hair region according to the preset number of particle bunches to correspondingly obtain at least one particle bunch; and meshing each of the at least one particle bunch according to the preset number of particles to correspondingly obtain at least one particle region.

In some embodiments, before acquiring the first target motion state and the target state change information of the first target particle region from the texture image, the hair rendering method further includes: determining a particle region at a preset position of the at least one particle bunch as the first target particle region.

The texture image of the target image frame is acquired according to the target video containing the hair information, and the texture image can be processed by a GPU (graphics processing unit); the hair region in the texture image is divided into at least one particle region, and the particle region is processed by the GPU, which greatly simplifies the graphics processing of the GPU and improves the graphics processing efficiency of the GPU, so that the computation on the mobile terminal is realized; in addition, the first target motion state and the target state change information of the target particle region are acquired from the texture image, based on which the second target motion state of the first target particle region in the next image frame is determined, and the motion state in the texture image is updated according to the second target motion state to realize the rendering of the hair region. The above technical solution according to the present disclosure is able to render the hair region in real time on the mobile terminal, and at the same time is able to modify the motion state of a particular particle region, so that a special rendering effect that particles flow along a direction of the hair filament may be realized.

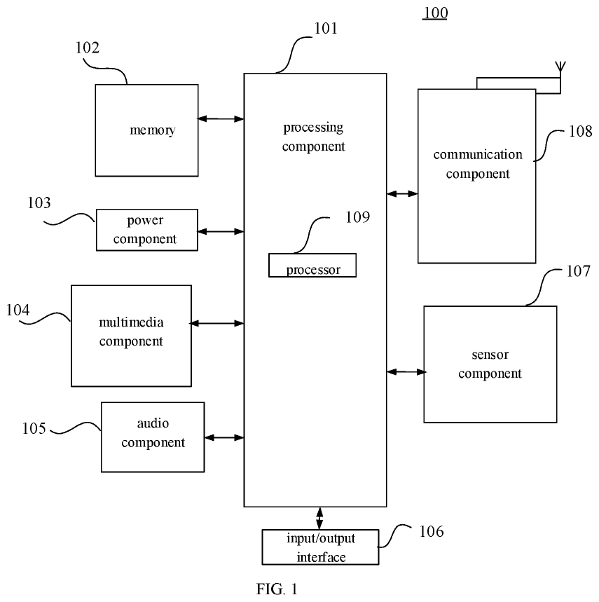

The hair rendering method provided in the present disclosure may be applied to a device 100 as shown in FIG. 1. The device 100 may be a mobile terminal, such as a mobile phone, a computer, a digital broadcast terminal, a messaging device, a gaming console, a tablet, a medical device, exercise equipment, a personal digital assistant, and the like.

Referring to FIG. 1, the device 100 may include one or more of the following components: a processing component 101, a memory 102, a power component 103, a multimedia component 104, an audio component 105, an input/output (I/O) interface 106, a sensor component 107, and a communication component 108. These components are described in detail as follows.

The processing component 101 typically controls overall operations of the device 100, such as operations associated with display, telephone calls, data communications, camera operations, and recording operations. The processing component 101 may include one or more processors 109 to execute instructions to perform all or part of the steps in the above-described method. Moreover, the processing component 101 may include one or more modules which facilitate interaction between the processing component 101 and other components. For instance, the processing component 101 may include a multimedia module to facilitate interaction between the multimedia component 104 and the processing component 101.

The memory 102 is configured to store various types of data to support the operation of the device 100. Examples of such data include instructions for any applications or methods operated on the device 100, contact data, phonebook data, messages, pictures, videos, etc. The memory 102 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 103 provides power to various components of the device 100. The power component 103 may include a power management system, one or more power sources, and any other components associated with the generation, management, and distribution of power in the device 100.

The multimedia component 104 includes a screen providing an output interface between the device 100 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 104 includes a front camera and/or a rear camera. The front camera and/or the rear camera may receive external multimedia data while the device 100 is in an operation mode, such as a photographing mode or a video mode. Each of the front camera and the rear camera may be a fixed optical lens system or have focus and optical zoom capability.

The audio component 105 is configured to output and/or input audio signals. For example, the audio component 105 includes a microphone (MIC) configured to receive an external audio signal when the device 100 is in an operation mode, such as a call mode, a recording mode, and a voice recognition mode. The received audio signal may be further stored in the memory 102 or transmitted via the communication component 108. In some embodiments, the audio component 105 further includes a speaker to output audio signals.

The I/O interface 106 provides an interface between the processing component 101 and a peripheral interface module, such as a keyboard, a click wheel, buttons, and the like. The buttons may include, but are not limited to, a home button, a volume button, a starting button, and a locking button.

The sensor component 107 includes one or more sensors to provide status assessments of various aspects of the device 100. For instance, the sensor component 107 may detect an open/closed status of the device 100, relative positioning of components, e.g., the display and the keyboard, of the device 100, a change in position of the device 100 or a component of the device 100, a presence or absence of user contact with the device 100, an orientation or an acceleration/deceleration of the device 100, and a change in temperature of the device 100. The sensor component 107 may include a proximity sensor configured to detect a presence of nearby objects without any physical contact. The sensor component 107 may also include a light sensor, such as a CMOS or CCD image sensor, for use in imaging applications. In some embodiments, the sensor component 107 may also include an accelerometer sensor, a gyroscope sensor, a magnetic sensor, a pressure sensor, or a temperature sensor.

The communication component 108 is configured to facilitate communication, wired or wireless, between the device 100 and other devices. The device 100 may access a wireless network based on a communication standard, such as WiFi, an operator network (such as 2G, 3G, 4G or 5G) or a combination thereof. In an exemplary embodiment, the communication component 108 receives a broadcast signal or broadcast associated information from an external broadcast management system via a broadcast channel. In an exemplary embodiment, the communication component 108 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the device 100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

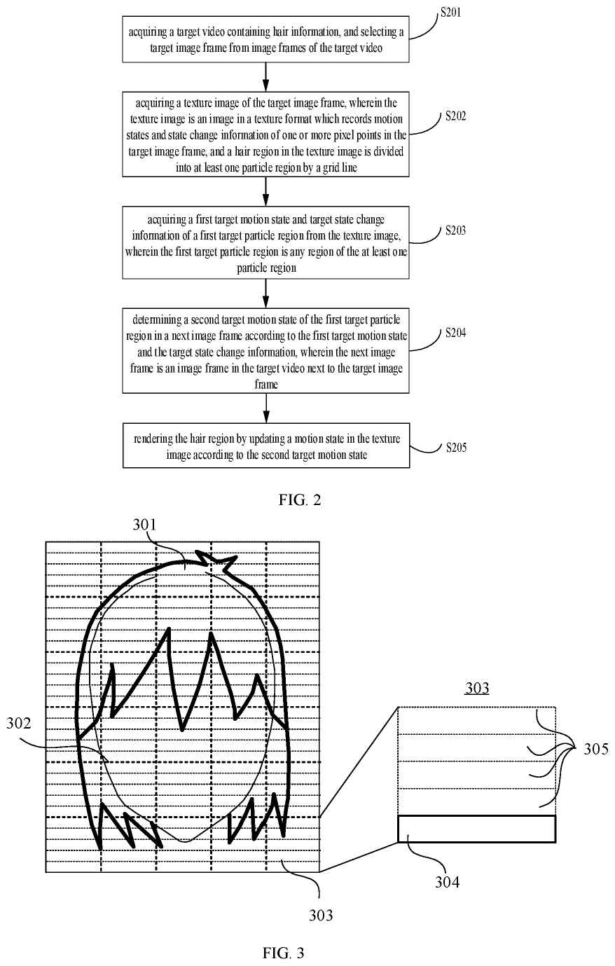

FIG. 2 is a flow chart of a hair rendering method according to an exemplary embodiment of the present disclosure, which may be applied to the device 100 as shown in FIG. 1 (specifically to the processor 109 as shown in FIG. 1, and more specifically to a GPU (graphics processing unit) of the device 100). As shown in FIG. 2, the hair rendering method includes the following steps S201/S202/S203/S204/S205, which are described in detail below.

In step S201, a target video containing hair information is acquired, and a target image frame is selected from image frames of the target video.

The target video may be a video obtained by shooting a head of a human body (or an animal body) through a shooting device. The shooting device may be the sensor component 107 of the device 100, or may be a camera that has a network connection relationship with the device 100.

The hair information contained in the target video may refer to a position where the hair region is located, a size of the hair region, a real-time position of the hair region, a hair color, a length and direction of a hair filament, and the like information.

The camera may shoot the target video containing the hair information within a set period of time, and send the shot target video to the device 100 (or directly to the processor of the device 100) for hair rendering by the processor. Furthermore, the camera may shoot target videos in advance and send the shot target videos to the device 100 together; or the camera may send the target video to the processor in real time during the shooting process.

Further, each time sequence of the target video corresponds to an image frame, and the device 100 may perform a hair rendering treatment on one or some image frames of the target video in one hair rendering program, and the one or some image frames may be understood as the target image frame. The target image frame may be an image frame randomly selected from the target video, or may be several consecutive image frames selected in a time sequence.

In step S202, a texture image of the target image frame is acquired. The texture image is an image in a texture format which records motion states and state change information of one or more pixel points in the target image frame, and a hair region in the texture image is divided into at least one particle region by a grid line.

The texture format is a pixel format that can be recognized by the GPU. The texture image in embodiments of the present disclosure is the image in the texture format. Further, the texture image may also be directly referred to as “texture” for short, which may be a half float (half floating-point) or float (floating-point) type texture map.

In this step, the texture image of the target image frame is acquired, which is processed by the GPU of the device. The hair region in the texture image may be determined according to the color of each pixel point in the target image frame. For example, a black region with an area larger than a set value is determined as the hair region, and then corresponding information is filled in a corresponding grid of the texture image to characterize the hair region in the texture image. Of course, the process of determining the hair region may also be implemented by machine learning. For example, a plurality of videos containing the hair information are input into a pre-built neural network model, and corresponding information of the hair region in each image frame of each video is also input into the neural network model, the neural network model uses the input information to perform self-learning and completes the training process, after which, the target video shot by the camera is input to the neural network model, and the neural network model can automatically output the hair region in each image frame of the target video.

Further, the hair region in the texture image is divided into at least one particle region (in some cases, other regions outside the hair region may also be meshed to obtain corresponding particle regions), and the at least one particle region may be obtained through dividing the texture image by the device 100, an external device of the device 100 or other components (such as the sensor component) other than the processor in the device 100, after the texture image is acquired. Furthermore, the hair region corresponding to the texture image may be divided according to the set number of grid lines, and the particle regions may be determined according to obtained grids; or the texture image may be divided according to the distribution of hair filaments, for example, hair bunches (a distance between the hair filaments is small enough) are determined as the particle regions. In addition, the number of the particle regions in the texture image may be determined according to an actual situation. In a case where the hair region needs to be rendered more accurately, the number of the particle regions may be larger. In a case where the hair region needs to be rendered more roughly, the number of the particle regions may be smaller.

Further, the target image frame may be an image frame displayed on a display screen of the device 100, that is, the texture image records particle information of the image frame currently displayed on the display screen, and the particle information includes the motion states and the state change information of one or more pixel point (for each pixel point, there may be a corresponding particle region) in the target image frame. The motion state is a state of a particle in a corresponding image frame, which may be position information, speed information (including a rate and a direction), a hair directional angle, a size, etc.; and the state change information may refer to information describing the state change of the particle, which can characterize the motion state of the particle in a next image frame, and may be a speed, a hair directional angle, a rotation direction, a life cycle, etc. It should be noted that some particle information may be either the motion state or the state change information. For example, the speed can not only characterize rate and direction information of a certain image frame (in this case, it may be used as the motion state), but also characterize a moving state of the image frame (in this case, it may be used as the state change information, and can determine a moving distance of the particle in combination with time information, so as to determine a position coordinate of the particle). Specifically, where a position of a particle in a next image frame needs to be computed, a speed may be used to evaluate the position of the particle at a next moment, in this case, the position information may be used as the movement state, while the speed may be used as the state change information; where a speed of a particle in a next image frame needs to be computed, a rate may be used to evaluate the speed of the particle at a next moment, in this case, the speed may be used as the movement state, while the rate may be used as the state change information. In these cases, the speed is used as either the motion state or the state change information.

In an exemplary embodiment, due to the limited storage channels in the texture image, in a case where one texture image is not enough to store the motion state or the state change information, two texture images may be used. For example, for texture images each having only 4 channels, two texture images may be used to store the position information, the speed information (including the rate and the direction), and other information in dimensions like the hair directional angle, the rotation direction, the life cycle, and the size.

In step S203, a first target motion state and target state change information of a first target particle region are acquired from the texture image. The first target particle region is any region of the at least one particle region.

Each particle in the texture image may have its own number, and the particle information of each particle is stored in a corresponding particle region of the texture image. The target particle region may be randomly selected from the particle regions of the texture image, or may be selected according to a specific rule (for example, selecting a particle region at a specific location). Further, from the particle information recorded in the target particle region, corresponding target motion state and state change information may be obtained, thereby obtaining the first target motion state and the target state change information.

The specific process of the step S203 may be implemented by: acquiring at least one of a screen coordinate, a speed, a directional angle, a rotation posture, a current life state, a life cycle, and a size of the target particle from the texture image, and obtaining the first target motion state and the target state change information according to the acquired information (the corresponding target state change information may be determined according to the motion state to be updated currently).

In an exemplary embodiment, after the step of acquiring the texture image of the target image frame, the method further includes: determining the hair region in the texture image; meshing the hair region according to the preset number of particle bunches to correspondingly obtain at least one particle bunch; and meshing each of the at least one particle bunch according to the preset number of particles to correspondingly obtain at least one particle region.

The number of the particle bunches is used to characterize the number of particle bunches contained in the hair region, and may be determined according to a screen resolution, a rendering precision, etc.; and the number of the particles is used to characterize the number of particle regions contained in the particle bunch, and may also be determined according to the screen resolution, the rendering precision, etc. Further, after the number of the particle bunches and the number of the particles are known, the hair region or the particle bunch may be divided by the grid lines at same or different intervals. Further, the hair region or the particle bunch may be divided horizontally, vertically, or both horizontally and vertically (in this case, the interval in a horizontal direction may be the same as or different from that in a vertical direction), or may be divided by lines at a certain angle (for example,)30° relative to a horizontal line of the screen.

A schematic diagram of the texture image may be as shown in FIG. 3, in which the left figure shows a girl's head profile, which includes a hair profile (indicated by thick solid lines) and a face profile (indicated by thin solid lines), and these two profiles constitute a hair region 301 and a face region 302, respectively. Further, the hair region 301 is divided into a plurality of particle bunches (each show as 305). As shown in FIG. 3, a grid region 303 surrounded by thick dashed lines may be understood as a particle bunch. Further, each of these particle bunches is divided into a plurality of small regions, and these small regions may be referred as the first target particle regions 304 (may also be referred as hair particles or particles, the specific division may be seen in the enlarged diagram at the right side of FIG. 3).

It should be noted that FIG. 3 shows a case where the entire texture image is meshed, however, in an actual application scenario, it is possible to only mesh the hair region (or the hair region and the face region). Furthermore, a video contains a plurality of frames, and because the head position may change, the hair region in each frame may also change. Therefore, after a texture image is acquired, it is possible to redetermine the hair region and mesh the hair region.

In an exemplary embodiment, before the step of acquiring the first target motion state and the target state change information of the first target particle region of the at least one particle region from the texture image, the method further includes: determining a particle region at a preset position of the at least one particle bunch as the first target particle region. The preset position may refer to a particle region at a center c, a head position (the position where the first number is located), or a tail position (the position where the last number is located) in a certain particle bunch.

Further, in embodiments of the present disclosure, the target particle region (as indicated by 304 in FIG. 3) is selected from a plurality of particle regions 305 of the particle bunch. The target particle region 304 may be randomly selected, or a particle at a center position or an edge position may be selected as the target particle region. In some exemplary embodiments, the target particle region may also be referred to as a head particle (this particle drives other particles to move during the rendering process). On the other hand, the selection method of the target particle in different particle bunches of the same texture image may be the same or different. For example, in the latter case, the selection of the target particle may be specifically implemented as follows: in a certain particle bunch, a particle region at an edge position may be selected as the target particle region, while in another particle bunch, a particle region at center position may be selected as the target particle region. In addition, the number of target particle regions corresponding to a particle bunch may be one, two or more. Furthermore, the target particle region may be those selected from partial or all particle bunches of the hair region, or from a certain particle bunch. By dividing the hair region in the texture image, the motion state of particular particle regions may be updated, so that these particle regions show a gradual change state in the final displayed video, thereby achieving a special rendering effect that particles flow in a direction of the hair filament.

In step 5204, a second target motion state of the first target particle region in a next image frame is determined according to the first target motion state and the target state change information. The next image frame is an image frame in the target video next to the target image frame.

The next image frame is an image frame of the target image frame at a next moment. The “next moment” may be determined according to a frame sampling rate. For example, assuming that 60 image frames are generated within 1 min (one image frame per second (s)), if the frame sampling rate is 5 s/frame, the next image frame is separated from the target image frame by 4 image frames, while if the frame sampling rate is 1 s/frame, the next image frame is separated from the target image frame by 0 image frames (that is, the next image frame is adjacent to the target image frame). Therefore, the selection of the image frame may be adjusted according to actual situations. For example, where a high rendering precision is required, the frame sampling rate may take a low value (more image frames need to be processed in this case), and where a low rendering precision is required, the frame sampling rate may take a high value.

The first target motion state characterizes the motion state of the first target particle region in the target image frame, and the target state change information characterizes the influence of the first target particle region on the state change in the target image frame. Therefore, based on the first target motion state and the target state change information, the motion state of the first target particle region in the next image frame may be obtained, that is, a second target motion state may be obtained. For example, the texture image contains the following particle information: a position coordinate of the first target particle region is (2,2), its speed direction is 36.87° relative to a positive direction of a screen horizontal line (may be recorded as an x-axis), and the speed value is 5 mm/s, among which the position coordinate belongs to the first target motion state, while the speed direction and the speed value belong to the target state change information. According to the above information, it can be determined that, from the target image frame to the next image frame (taking the time interval between the target image frame and the next image frame is 1 s as example), the first target particle region moves 3 mm in the positive direction of the x-axis, and moves 4 mm in a y-axis. Therefore, it can be determined that the position coordinate of the first target particle region in the next image frame are (5,6), so the second target motion state is obtained.

In step S205, the hair region is rendered by updating a motion state in the texture image according to the second target motion state. Updating the motion state in the texture image may be understood as directly replacing the first target motion state in the texture image with the second target motion state.

The display screen of the device 100 displays the target image frame according to the texture image at the beginning. After the texture image is updated, the corresponding next image frame may be displayed on the display screen. At this time, the motion state of the first target particle region in the screen will change from the first target motion state to the second target motion state, thereby achieving a rendering effect that particular particles in the hair region is flowing.

Further, the completion of the switch between the target image frame and the next image frame may be regarded as the completion of the rendering of the hair region for one time. Next, new rendering may be continued.

In the above-described hair rendering method, the texture image of the target image frame is acquired according to the target video containing the hair information, and the texture image can be processed by the GPU; the hair region in the texture image is divided into at least one particle region, and the particle region is processed by the GPU, which greatly simplifies the graphics processing of the GPU and improves the graphics processing efficiency of the GPU, so that the computation on the mobile terminal is realized; in addition, the first target motion state and the target state change information of the target particle region are acquired from the texture image, based on which the second target motion state of the first target particle region in the next image frame is determined, and the motion state in the texture image is updated according to the second target motion state to realize the rendering of the hair region. The above technical solution according to the present disclosure is able to render the hair region in real time on the mobile terminal, and at the same time is able to modify the motion state of a particular particle region, so that a special rendering effect that particles flow along the direction of the hair filament may be realized.

In an exemplary embodiment, the step of updating the motion state in the texture image according to the second target motion state includes: updating a motion state of the first target particle region according to the second target motion state, and retaining a motion state of a remaining particle region (also referred to as a tail particle region or a tail particle). The remaining particle region is a particle region of the at least one particle region other than the first target particle region.

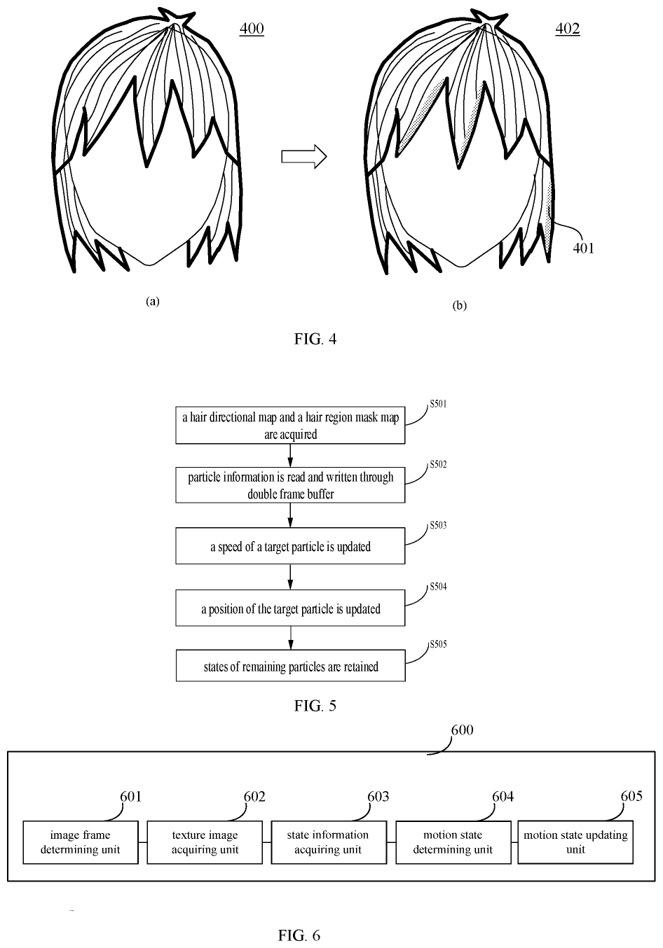

As shown in the enlarged diagram of the part marked as 303 in FIG. 3, all or part of the particles in the particle bunch other than the first target particle region 304 may be regarded as the remaining particle region, as indicated by 305 in FIG. 3. In an exemplary embodiment, the process for determining the first target particle region 304 and the remaining particle region 305 may be as follows: assuming that the texture image storing the particle information has a resolution of W*H, and there are m particles and n particles distributed in W and H directions, respectively, so the total number of particles is m*n, where m≤W, and n≤H; assuming that each particle bunch is composed of K particles, n/K grids are divided in the H direction, and each grid stores information of a bunch of particles. Each grid is divided into K subintervals k(i), where i ranges from 0 to K−1, in which k(0) is the target particle (i.e., the head particle) of the particle bunch, while k(1) to k(K−1) are remaining particles (i.e., tail particles) of the particle bunch. Among others, the values of W/H/m/n/K/k may be determined according to actual situations. In embodiments of the present disclosure, the motion state of the remaining particle region 305 in the next image frame directly adopts the motion state of the remaining particle region 305 in the target image frame, while the motion state of the first target particle region 304 is updated in real time. Based on this, the display state in the display screen is that: the state of the first target particle region 304 changes, while the state of the remaining particle region 305 does not change. In this way, display of the next image frame after display of the target image frame will generate a “tailing” effect, which has high applicability in games and other scenarios that require a “tailing” effect. Referring to FIG. 4, a schematic display diagram of the hair region of the target image frame may be as shown by a left FIG. 400 of FIG. 4 (the grid lines may not be displayed), from which the state of the hair filament can be seen clearly; after rendering, the hair region with tailing effect may be as shown by a right FIG. 402 of FIG. 4, in which the gray region 401 may be the first target particle region, and the hair filament in the first target particle region is blurred due to motion during frame switching, while the state of particles in other regions remains unchanged, and the hair filament can still be seen clearly, so that the special rendering effect that the particle bunch flows along the direction of the hair filament and the “tailing” effect are realized. In an exemplary embodiment, the motion state of the remaining particle region in the next image frame may not adopt the corresponding reference remaining motion state in the target image frame, but is obtained by: acquiring a candidate remaining motion state in accordance with the determination method of the second target motion state, determining a difference between the candidate remaining motion state and the reference remaining motion state, multiplying the difference by a certain percentage (for example, 30%) and summing the obtained product with the reference remaining motion state to obtain the motion state of the remaining particle region in the next image frame. In this way, the state of the remaining particles also will change in the rendering process, but the magnitude of the change is not as large as the target particle, so that the “tailing” effect can be generated, and the flow of the hair is more natural.

Further, in an exemplary embodiment, the target particle region or the remaining particle region may be subjected to other operations like color rendering (for example, replacing black particles with golden particles) according to the needs of the scenario.

In an exemplary embodiment, the first target motion state includes a first screen coordinate, and the target state change information includes a first speed. The determining the second target motion state of the first target particle region in the next image frame according to the first target motion state and the target state change information includes: determining a time difference between the target image frame and the next image frame; determining a second screen coordinate of the first target particle region in the next image frame according to the first screen coordinate, the first speed and the time difference; and determining the second target motion state based on the second screen coordinate.

The time difference between the target image frame and the next image frame may be determined according to the frame sampling rate as described in the foregoing embodiments. Further, it may be determined according to an overall frame rate of a video effect. For example, the frame rate of the special effect set by a certain app product is 30 fps, then the time difference (delta t) between adjacent image frames is about 1000/30=33 ms, if the target image frame and the next image frame are adjacent, then the time difference between the target image frame and the next image frame is 33 ms.

The screen coordinate may be understood as a position coordinate of the vertex of the first target particle region in the display screen of the device 100.

Further, the screen coordinate of the first target particle region may be updated by updating the vertex position of the first target particle region, but not updating other positions.

In embodiments of the present disclosure, the second screen coordinate of the first target particle region in the next image frame is determined according to the first screen coordinate, the first speed and the time difference, and the second target motion state is determined based on the second screen coordinate. In some embodiments, the second screen coordinate is regarded as the second target motion state. The process for determining the motion state is simple, which can effectively improve the rendering efficiency of the hair region and realize real-time rendering on the mobile terminal.

Further, in an exemplary embodiment, the step of updating the motion state in the texture image according to the second target motion state includes: in response to the second screen coordinate being outside the hair region, redetermining the hair region of the texture image and determining a second target particle region from particle regions corresponding to the redetermined hair region; acquiring a reference target motion state and a reference target state change information of the second target particle region from the texture image; obtaining a third target motion state by determining a motion state of the second target particle region in the next image frame according to the reference target motion state and the reference target state change information; and updating the motion state in the texture image according to the third target motion state.

The second screen coordinate may be compared with the coordinate of each particle region in the hair region, and in response to the second screen coordinate being not matched with the coordinate of any particle region in the hair region, it is determined that the second screen coordinate is outside the hair region.

It should be noted that, for the step of “obtaining a third target motion state by determining the motion state of the second target particle region in the next image frame according to the reference target motion state and the reference target state change information”, reference may be made to the process of “determining the second target motion state of the first target particle region in the next image frame according to the first target motion state and the target state change information” as described in the above embodiments, and for the step of “updating the motion state in the texture image according to the third target motion state”, reference may be made to the process of “updating the motion state in the texture image according to the second target motion state” as described in the above embodiments, both of which will not be elaborated here again. In embodiments of the present disclosure, in a case where it is determined that the target particle is outside the hair region corresponding to the target image frame, the motion state (i.e., the third target motion state) of the target particle is redetermined, and the texture image is updated according to the third target motion state, which ensures the continuity of the hair region displayed on the display screen, so that sudden deformation of the hair region will not occur, thereby ensuring good hair display effect.

In an exemplary embodiment, in a case where a screen coordinate corresponding to the third target motion state is still outside the hair region, a new motion state may be determined according to the third target motion state and third target state change information, and so on, until the determined screen coordinate is in the hair region. Of course, in some cases where the determined screen coordinate (including the aforementioned second screen coordinate) is outside the hair region, but its distance from the edge of the hair region is less than a preset threshold (the threshold may be determined according to actual situations, which will not be limited herein), the texture image may be directly updated according to the second target motion state without redetermining the motion state, which can effectively reduce the amount of computation while ensuring good hair display effect.

In an exemplary embodiment, the first target motion state includes a second speed, and the target state change information includes a hair directional angle. The step of determining the second target motion state of the first target particle region in the next image frame according to the first target motion state and the target state change information includes: acquiring a preset rate; and obtaining the second target motion state by determining a third speed of the first target particle region in the next image according to the second speed, the hair directional angle and the preset rate.

It should be noted that both the first speed and the second speed are speed information obtained from a certain channel in the same texture image, and their magnitudes may be the same. When updating the screen coordinate, if the screen coordinate is to be updated according to the speed, the speed is used as the state change information; when updating the speed, the speed is used as the motion state.

The rate may also be called as velocity scalar, which is used to control the flow rate of particles. The rate may be preset by a user or may be determined by a certain algorithm (for example, the velocity scalar gradually decreases with time).

The hair directional angle may refer to an angle of the speed of the first target particle region relative to the positive direction of the screen horizontal line, the x-axis, and the hair directional angle may be understood as a motion direction of the first target particle region and may be represented by D(cost, sint), where t represents an angle of the target particle relative to the positive direction of the x-axis, cost represents a component of a moving distance of the first target particle region in the x-axis, and sint represents a component of the moving distance of the first target particle region in the y-axis.

Further, the third speed may be computed by the following formula:

the third speed=the second speed+the hair directional angle * the rate,

where the second speed includes a speed value and a directional angle. Therefore, the summing of “the second speed” and “the hair directional angle * the rate” not only includes the summing of the speed values, but also include the fusion of the directional angles.

In another exemplary embodiment, the second speed may not be considered in the determination of the third speed, and the product of the hair directional angle and the rate may be directly used as the third speed. The specific computation formula may be as follows:

the third speed v(u,v)=D(cost, sint) * V,

where D(cost, sint) represents the hair directional angle, and V is a user-defined rate. In this way, the speed of the first target particle region may be controlled by the device 100, so that the flow rate of the hair filament may be controlled according to the needs of the user, so as to achieve a more personalized hair display effect.

In the above embodiment, the speed information of the next image frame is determined according to the directional angle and the rate, and the determination process is simple, which can effectively improve the computation efficiency and realize the real-time rendering on the mobile terminal.

In an exemplary embodiment, before the step of acquiring the texture image of the target image frame, the hair rendering method further includes: determining candidate state change information of each pixel point in the target image frame according to pixel state information in the target video which varies over time; acquiring a hair directional map and a hair region mask map corresponding to the target image frame, wherein the hair directional map includes a hair directional angle of the pixel point, and the hair region mask map includes mask information of the hair region in the target image frame; determining a candidate motion state of the pixel point according to the hair directional angle in the hair directional map and the mask information in the hair region mask map; and storing the candidate state change information and the candidate motion state to a vertex position of the at least one particle region, wherein the vertex position of the at least one particle region corresponds to the pixel point.

The pixel state information may refer to state information related to such as color and position of each pixel in the video and the relationship of state change between pixel points over time (for example, in a certain frame, a certain pixel point P1 is pure black, but in the next frame, the pixel point P2 adjacent to the pixel point P1 changes to pure black, while the pixel point P1 changes to other colors). A particle may correspond to one or more pixel point (there is a mapping relationship between the particle and the pixel point). The state change information (such as moving speed, etc.) of each particle may be determined according to the pixel state information of the corresponding pixel point, so as to obtain the candidate state change information.

The hair directional angle indicates the direction of the hair filament, and the hair directional angles t of the particles are arranged correspondingly to form the hair directional map. In other embodiments, the hair directional map may also store values of cos 2t and sin 2t to prevent the ambiguity of the hair direction on the same straight line. When the hair directional angle needs to be processed, the cost and sint may be determined by the following formulas, respectively:

cost=sqrt((1+cos 2t)/2)*sign(sin 2t);

sint=sqrt(1-cost\hat{ }2),

where sign represents a sign function.

Further, t may be determined by: Sa. computing a grayscale image of the target image frame; Sb. computing a gradient image of the grayscale image; Sc. blurring the gradient image; and Sd.

taking a vertical vector of the blurred gradient image obtained in step Sc as the direction vector of each pixel, thereby obtaining t.

The mask is a string of binary codes that performs bitwise operations on a target field. The mask information of the hair region may indicate whether the particle is in the hair region. The mask information of the particles is arranged together to form the hair region mask map.

The directional angle of each particle may be obtained according to the hair directional angle in the hair directional map of a certain image frame, while the position information, the size and the like of each particle may be obtained according to the hair region mask map of the image frame. Further, based on the hair directional maps of adjacent image frames, the rotation direction of each particle may be obtained; and based on the hair region mask maps of adjacent image frames, the life cycle (for example, in a case where a certain particle is generated in image frame A and disappears in image frame B, the number of frames between the image frame A and the image frame B may be used as the life cycle of the particle), the speed information (for example, a certain particle is at position c in image frame C and at position d in image frame D, then the speed information of the particle may be determined according to a distance between the position c and the position d and a time difference between the image frame C and the image frame D) of each particle may be obtained.

In addition, the hair directional map and the hair region mask map may be obtained from the information of the target video through the neural network model. The neural network model may be a CNN (convolutional neural network) model or the like.

In the above embodiment, the candidate motion state and the candidate state change information of the target image frame are determined according to the information of the target video, and are stored in the texture image, which belong to the pre-processing of the target video, so that the subsequent hair rendering process can be carried out orderly.

In an exemplary embodiment, after the step of storing the candidate state change information and the candidate motion state to the vertex position of the at least one particle region, the hair rendering method further includes: storing the texture image to a first frame buffer; and after the step of updating the motion state in the texture image according to the second target motion state, the method further includes: storing the texture image in the first frame buffer to a second frame buffer; and storing an updated texture image to the first frame buffer.

In embodiments of the present disclosure, the candidate state change information and the candidate motion state, after acquired, are stored in the corresponding vertex position in the texture image for later use. In a case where the hair needs to be rendered, the candidate state change information and the candidate motion state corresponding to the target image frame are obtained from the texture image as the target state change information and the first target motion state, respectively.

In embodiments of the present disclosure, the texture image is stored by two frame buffers, i.e., the first frame buffer and the second frame buffer. The texture image stored in the first frame buffer may be used as output (that is, displayed on the display screen), and the texture image stored in the second frame buffer may be used as input. For example, when the image frame needs to be displayed, the texture image in the first frame buffer is input into the second frame buffer, so that output display of the image frame is performed according to the texture image in the first frame buffer.

In addition, the input and output may also be switched between the first frame buffer and the second frame buffer. For example, at the current moment, the texture image in the first frame buffer is output, and the second frame buffer is used as a backup of the first frame buffer to store the texture image corresponding to the next image frame; at the next moment, the texture image corresponding to the next image frame is output from the second frame buffer, and the first frame buffer is used as a backup of the second frame buffer, and a newly determined texture image corresponding to an image frame next to the next image frame is stored in the first frame buffer.

The above embodiments use double buffers to store the texture image, which can ensure the orderliness of the input and output of the information in the texture image, prevent data loss, and ensure the accuracy of hair rendering.

In an exemplary embodiment, a flow chart of a hair rendering method is provided. The hair rendering method is applied to the device as shown in FIG. 1, and nay be implemented as follows, as illustrated in FIG. 5.

In S501, a hair directional map and a hair region mask map are acquired.

In S502, particle information is read and written through double frame buffer. The particle information of a target image frame is acquired from the hair directional map and the hair region mask map, the obtained particle information includes: a speed, a position, a rotation posture, a current life state and a size of a particle and a direction of a hair filament, and the obtained particle information is stored by two pieces of texture. The texture that records the particle information is stored in the first frame buffer, and another frame buffer is used as a backup of the first frame buffer. For example, for the position, the acquisition process may be: initializing two pieces of texture, randomly generating particles on the full screen, and in response to a certain particle being in the hair region, writing a screen coordinate of the particle into the frame buffer; for the direction of the hair filament, cost and sint are determined according to cos 2t and sin 2t stored in the hair directional map, so as to obtain the direction of the hair filament, D(cost, sint).

In S503, a speed of a target particle is updated. A speed v2(u,v) of the target particle in the next image frame is determined according to the direction of the hair filament, D(cost, sint) and a velocity scalar V: v2(u,v)=D(cost, sint)*V, and the speed of the target image frame is updated according to the speed v2(u,v).

In S504, a position of the target particle is updated. A position of the target particle in the next image frame is determined according to a particle speed vl(u,v) in the target image frame: P(u,v)=P_prev(u, v)+vl(u,t)*delta_t, where P_prev(u, v) represents the position of the target particle in the target image frame, delta_t represents a time increment, and P_prev(u, v) is updated according to P(u,v). In a case where the updated particle position is out of the range of the hair region, a random particle position is regenerated on the screen, and the position is redetermined and updated.

In S505, states of remaining particles are retained. The speed and position of the remaining particles in the next image frame adopt the speed and position in the target image frame.

The foregoing embodiments achieves the following beneficial effects:

1. The hair particles are integrated into particle bunches, which avoids the disorder of the hair and realizes the smooth rendering effect of “optical flow”.

2. Most video effects implemented with traditional techniques are relatively simple, while the GPU particle technology is complex to implement, so it is difficult to promote it into a fixed mode. Therefore, the general demand still uses traditional CPU computing to realize particle system. However, the foregoing embodiments use the GPU to implement the computation of the particle information, which makes the GPU particle system implemented, and greatly improves the computing efficiency of the particle system, so that real-time rendering of the hair on the mobile terminal is realized.

It should be understood that although the steps in the flow charts of FIG. 2 and FIG. 5 are sequentially displayed according to the arrows, these steps are not necessarily executed in the order indicated by the arrows. Unless explicitly stated herein, the order of execution of these steps is not strictly limited, and the steps may be executed in other orders. Moreover, at least a part of the steps in FIG. 2 and FIG. 5 may include multiple steps or multiple stages, and these steps or stages are not necessarily executed at the same time, but may be executed at different moments. These steps or stages are also not necessarily to be performed sequentially, but may be performed in turn or alternately with other steps or at least a portion of the steps or stages in the other steps.

FIG. 6 is a block diagram of a hair rendering apparatus 600 according to an exemplary embodiment. Referring to FIG. 6, the apparatus includes an image frame determining unit 601, a texture image acquiring unit 602, a state information acquiring unit 603, a motion state determining unit 604 and a motion state updating unit 605.

The image frame determining unit 601 is configured to acquire a target video containing hair information, and select a target image frame from image frames of the target video.

The texture image acquiring unit 602 is configured to acquire a texture image of the target image frame. The texture image is an image in a texture format which records motion states and state change information of one or more pixel points in the target image frame, and a hair region in the texture image is divided into at least one particle region by a grid line.

The state information acquiring unit 603 is configured to acquire a first target motion state and target state change information of a first target particle region from the texture image.

The motion state determining unit 604 is configured to determine a second target motion state of the first target particle region in a next image frame according to the first target motion state and the target state change information. The next image frame is an image frame in the target video next to the target image frame.

The motion state updating unit 605 is configured to render the hair region by updating a motion state in the texture image according to the second target motion state.

With the hair rendering apparatus provided by above embodiments of the present disclosure, the texture image of the target image frame is acquired according to the target video containing the hair information, and the texture image can be processed by the GPU; the hair region in the texture image is divided into at least one particle region, and the particle region is processed by the GPU, which greatly simplifies the graphics processing of the GPU and improves the graphics processing efficiency of the GPU, so that the computation on the mobile terminal is realized; in addition, the first target motion state and the target state change information of the target particle region are acquired from the texture image, based on which the second target motion state of the first target particle region in the next image frame is determined, and the motion state in the texture image is updated according to the second target motion state to realize the rendering of the hair region. The above technical solution according to the present disclosure is able to render the hair region in real time on the mobile terminal, and at the same time is able to modify the motion state of a particular particle region, so that a special rendering effect that particles flow along the direction of the hair filament may be realized.

In an exemplary embodiment, the motion state updating unit is further configured to update a motion state of the first target particle region according to the second target motion state, and retain a motion state of a remaining particle region. The remaining particle region is a particle region of the at least one particle region other than the first target particle region.

In an exemplary embodiment, the first target motion state includes a first screen coordinate, and the target state change information includes a first speed. The motion state determining unit includes: a time difference determining subunit, configured to determine a time difference between the target image frame and the next image frame; and a first motion state determining subunit, configured to determine a second screen coordinate of the first target particle region in the next image frame according to the first screen coordinate, the first speed and the time difference; and determine the second target motion state based on the second screen coordinate.

In an exemplary embodiment, the motion state updating unit includes: a particle region determining subunit, configured to: in response to the second screen coordinate being outside the hair region, redetermine the hair region of the texture image and determine a second target particle region from particle regions corresponding to the redetermined hair region; a state information acquiring subunit, configured to acquire a reference target motion state and reference target state change information of the second target particle region from the texture image; a second motion state determining subunit, configured to obtaining a third target motion state by determining a motion state of the second target particle region in the next image frame according to the reference target motion state and the reference target state change information; and a motion state updating subunit, configured to update the motion state in the texture image according to the third target motion state.

In an exemplary embodiment, the first target motion state includes a second speed, and the target state change information includes a hair directional angle. The motion state determining unit includes: a rate acquiring subunit, configured to acquire a preset rate; and a third motion state determining subunit, configured to obtain the second target motion state by determining a third speed of the first target particle region in the next image according to the second speed, the hair directional angle and the preset rate.

In an exemplary embodiment, the hair rendering apparatus further includes: a state change information determining unit, configured to determine candidate state change information of each pixel point in the target image frame according to pixel state information in the target video which varies over time; an image acquiring unit, configured to acquire a hair directional map and a hair region mask map corresponding to the target image frame, wherein the hair directional map includes a hair directional angle of the pixel point, and the hair region mask map includes mask information of the hair region in the target image frame; a candidate motion state determining unit, configured to determine a candidate motion state of the pixel point according to the hair directional angle in the hair directional map and the mask information in the hair region mask map; and a candidate motion state storing unit, configured to store the candidate state change information and the candidate motion state to a vertex position of the at least one particle region, wherein the vertex position of the at least one particle region corresponds to the pixel point.

In an exemplary embodiment, the hair rendering apparatus further includes: a first image storing unit, configured to store the texture image to a first frame buffer; an image dumping unit, configured to store the texture image in the first frame buffer to a second frame buffer; and a second image storing unit, configured to store the updated texture image to the first frame buffer.

In an exemplary embodiment, the hair rendering apparatus further includes: a region determining unit, configured to determine the hair region in the texture image; a region dividing unit, configured to mesh the hair region according to the preset number of particle bunches to correspondingly obtain at least one particle bunch; and a particle bunch dividing unit, configured to mesh each of the at least one particle bunch according to the preset number of particles to correspondingly obtain at least one particle region.

In an exemplary embodiment, the hair rendering apparatus further includes: a particle region determining unit, configured to determine a particle region at a preset position of the at least one particle bunch as the first target particle region.

Regarding the apparatus in the above-mentioned embodiments, the specific manner in which each module performs the operation has been described in detail in the embodiments of the related method, which will not be elaborated here.

In an exemplary embodiment, there is also provided an electronic device, the schematic diagram of which may be as shown in FIG. 1. The electronic device includes: a processor; and a memory, configured to store an instruction executable by the processor. The processor is configured to execute the instruction to implement the hair rendering method as described in embodiments hereinbefore.

In an exemplary embodiment, there is also provided a non-transitory computer readable storage medium including instructions, such as the memory 102 including instructions, and the instructions are executable by the processor 101 of the electronic device 100 to perform the hair rendering method as described in embodiments hereinbefore. For example, the non-transitory computer-readable storage medium may be a read-only memory (ROM), a random access memory (RAM), a CD-ROM, a magnetic tape, a floppy disc, an optical data storage device, and the like.

In an exemplary embodiment, there is provided a computer program product. The program product includes a computer program, and the computer program is stored in a readable storage medium. The computer program, when read from the readable storage medium and executed by at least one processor of a device, causes the device to perform the hair rendering method as described in embodiments hereinbefore.

Other embodiments of the present disclosure will be apparent to those skilled in the art from consideration of the specification and practice of the present disclosure disclosed herein. The present disclosure is intended to cover any variations, uses, or adaptive modifications of the present disclosure following the general principles of the present disclosure and including common general knowledge or conventional techniques in the art not disclosed by this disclosure. It is intended that the specification and embodiments are merely considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure is only limited by the appended claims.

What is claimed is:

1. A hair rendering method, comprising:
acquiring a target video containing hair information, and selecting a target image frame from image frames of the target video;
acquiring a texture image of the target image frame, wherein the texture image is an image in a texture format which records motion states and state change information of one or more pixel points in the target image frame, and a hair region in the texture image is divided into at least one particle region by a grid line;
acquiring a first target motion state and target state change information of a first target particle region from the texture image, wherein the first target particle region is any region of the at least one particle region;
determining a second target motion state of the first target particle region in a next image frame according to the first target motion state and the target state change information, wherein the next image frame is an image frame in the target video next to the target image frame; and
rendering the hair region by updating a motion state in the texture image according to the second target motion state.

2. The hair rendering method according to claim 1, wherein said updating the motion state in the texture image according to the second target motion state comprises:
updating a motion state of the first target particle region according to the second target motion state, and retaining a motion state of a remaining particle region, wherein the remaining particle region is a particle region of the at least one particle region other than the first target particle region.

3. The hair rendering method according to claim 1, wherein the first target motion state comprises a first screen coordinate, and the target state change information comprises a first speed;
said determining the second target motion state of the first target particle region in the next image frame according to the first target motion state and the target state change information comprises:
determining a time difference between the target image frame and the next image frame;
determining a second screen coordinate of the first target particle region in the next image frame according to the first screen coordinate, the first speed and the time difference; and
determining the second target motion state based on the second screen coordinate.

4. The hair rendering method according to claim 3, wherein said updating the motion state in the texture image according to the second target motion state comprises:
in response to the second screen coordinate being outside the hair region, redetermining the hair region of the texture image and determining a second target particle region from particle regions corresponding to the redetermined hair region;
acquiring a reference target motion state and a reference target state change information of the second target particle region from the texture image;
obtaining a third target motion state by determining a motion state of the second target particle region in the next image frame according to the reference target motion state and the reference target state change information; and
updating the motion state in the texture image according to the third target motion state.

5. The hair rendering method according to claim 1, wherein the first target motion state comprises a second speed, and the target state change information comprises a hair directional angle;
said determining the second target motion state of the first target particle region in the next image frame according to the first target motion state and the target state change information comprises:
acquiring a preset rate; and
obtaining the second target motion state by determining a third speed of the first target particle region in the next image according to the second speed, the hair directional angle and the preset rate.

6. The hair rendering method according to claim 1, further comprising:
determining candidate state change information of each pixel point in the target image frame according to pixel state information in the target video which varies over time;
acquiring a hair directional map and a hair region mask map corresponding to the target image frame, wherein the hair directional map comprises a hair directional angle of the pixel point, and the hair region mask map comprises mask information of the hair region in the target image frame;
determining a candidate motion state of the pixel point according to the hair directional angle in the hair directional map and the mask information in the hair region mask map; and
storing the candidate state change information and the candidate motion state to a vertex position of the at least one particle region, wherein the vertex position of the at least one particle region corresponds to the pixel point.

7. The hair rendering method according to claim 6, after storing the candidate state change information and the candidate motion state to the vertex position of the at least one particle region, further comprising:
storing the texture image to a first frame buffer;
wherein after updating the motion state in the texture image according to the second target motion state, the method further comprises:
storing the texture image in the first frame buffer to a second frame buffer; and
storing an updated texture image to the first frame buffer.

8. The hair rendering method according to claim 1, after acquiring the texture image of the target image frame, further comprising:
determining the hair region in the texture image;
meshing the hair region according to the preset number of particle bunches to correspondingly obtain at least one particle bunch; and
meshing each of the at least one particle bunch according to the preset number of particles to correspondingly obtain at least one particle region.

9. The hair rendering method according to claim 8, before acquiring the first target motion state and the target state change information of the first target particle region from the texture image, further comprising:
determining a particle region at a preset position of the at least one particle bunch as the first target particle region.

10. An electronic device, comprising:
a processor;
a memory, configured to store an instruction executable by the processor,
wherein the processor is configured to execute the instruction to:
acquire a target video containing hair information, and select a target image frame from image frames of the target video;
acquire a texture image of the target image frame, wherein the texture image is an image in a texture format which records motion states and state change information of one or more pixel points in the target image frame, and a hair region in the texture image is divided into at least one particle region by a grid line;
acquire a first target motion state and target state change information of a first target particle region from the texture image, wherein the first target particle region is any region of the at least one particle region;
determine a second target motion state of the first target particle region in a next image frame according to the first target motion state and the target state change information, wherein the next image frame is an image frame in the target video next to the target image frame; and
render the hair region by updating a motion state in the texture image according to the second target motion state.

11. The electronic device according to claim 10, wherein the processor is configured to execute the instruction to:
update a motion state of the first target particle region according to the second target motion state, and retain a motion state of a remaining particle region, wherein the remaining particle region is a particle region of the at least one particle region other than the first target particle region.

12. The electronic device according to claim 10, wherein the first target motion state comprises a first screen coordinate, and the target state change information comprises a first speed;
wherein the processor is configured to execute the instruction to:
determine a time difference between the target image frame and the next image frame;
determine a second screen coordinate of the first target particle region in the next image frame according to the first screen coordinate, the first speed and the time difference; and
determine the second target motion state based on the second screen coordinate.

13. The electronic device according to claim 12, wherein the processor is configured to execute the instruction to:
in response to the second screen coordinate being outside the hair region, redetermine the hair region of the texture image and determining a second target particle region from particle regions corresponding to the redetermined hair region;
acquire a reference target motion state and a reference target state change information of the second target particle region from the texture image;
obtain a third target motion state by determining a motion state of the second target particle region in the next image frame according to the reference target motion state and the reference target state change information; and
update the motion state in the texture image according to the third target motion state.

14. The electronic device according to claim 10, wherein the first target motion state comprises a second speed, and the target state change information comprises a hair directional angle;
wherein the processor is configured to execute the instruction to:
acquire a preset rate; and
obtain the second target motion state by determining a third speed of the first target particle region in the next image according to the second speed, the hair directional angle and the preset rate.

15. The electronic device according to claim 10, wherein the processor is further configured to execute the instruction to:
determine candidate state change information of each pixel point in the target image frame according to pixel state information in the target video which varies over time;
acquire a hair directional map and a hair region mask map corresponding to the target image frame, wherein the hair directional map comprises a hair directional angle of the pixel point, and the hair region mask map comprises mask information of the hair region in the target image frame;
determine a candidate motion state of the pixel point according to the hair directional angle in the hair directional map and the mask information in the hair region mask map; and
store the candidate state change information and the candidate motion state to a vertex position of the at least one particle region, wherein the vertex position of the at least one particle region corresponds to the pixel point.

16. The electronic device according to claim 15, wherein the processor is configured to execute the instruction to store the texture image to a first frame buffer;
wherein the processor is further configured to execute the instruction to:
store the texture image in the first frame buffer to a second frame buffer; and
store an updated texture image to the first frame buffer.

17. The electronic device according to claim 10, wherein the processor is configured to execute the instruction to:
determine the hair region in the texture image;
mesh the hair region according to the preset number of particle bunches to correspondingly obtain at least one particle bunch; and
mesh each of the at least one particle bunch according to the preset number of particles to correspondingly obtain at least one particle region.

18. The electronic device according to claim 17, wherein the processor is configured to execute the instruction to:
determine a particle region at a preset position of the at least one particle bunch as the first target particle region.

19. A storage medium having stored therein instructions that, when executed by a processor of an electronic device, cause the electronic device to:
acquire a target video containing hair information, and select a target image frame from image frames of the target video;
acquire a texture image of the target image frame, wherein the texture image is an image in a texture format which records motion states and state change information of one or more pixel points in the target image frame, and a hair region in the texture image is divided into at least one particle region by a grid line;
acquire a first target motion state and target state change information of a first target particle region from the texture image, wherein the first target particle region is any region of the at least one particle region;
determine a second target motion state of the first target particle region in a next image frame according to the first target motion state and the target state change information, wherein the next image frame is an image frame in the target video next to the target image frame; and
render the hair region by updating a motion state in the texture image according to the second target motion state to.

20. The storage medium according to claim 19, wherein the instructions, when executed by the processor of the electronic device, cause the electronic device to: update a motion state of the first target particle region according to the second target motion state, and retain a motion state of a remaining particle region, wherein the remaining particle region is a particle region of the at least one particle region other than the first target particle region.
